(19) United States
(12) Patent Application Publication
(10) Pub. No.: US 2021/0340408 A1
(43) Pub. Date: Nov. 4, 2021

(54) UV-CURABLE HOT MELT ADHESIVE COMPOSITIONS FOR FLOORING APPLICATIONS

(71) Applicant: BASF SE, Ludwigshafen am Rhein (DE)

(72) Inventors: Augusto Ramos CUCALA, Charlotte, NC (US); Glen CUNKLE, Royal Oak, MI (US); Singa D. TOBING, Southfield, MI (US); Sujith CHACKO, Charlotte, NC (US); Limei LU, Florham Park, NJ (US); Matthias GERST, Ludwigshafen am Rhein (DE)

(73) Assignee: BASF SE, Ludwigshafen am Rhein (DE)

(21) Appl. No.: 17/274,182

(22) PCT Filed: Sep. 5, 2019
(86) PCT No.: PCT/US2019/049682

§ 371 Date: Mar. 7, 2021

Related U.S. Application Data
(60) Provisional application No. 62/728,495, filed on Sep. 7, 2018.

(51) Int. Cl. C09J 7/35; C09J 7/24

(52) U.S. Cl. CPC C09J 7/35; C09J 2433/00; C09J 2301/416; C09J 7/245

(57) ABSTRACT

A floor covering includes a floor covering element having an obverse face and a reverse face; an adhesive layer applied to the reverse face; and a release liner in adherence to the adhesive layer; where the adhesive layer includes a UV-curable hot melt adhesive composition that includes a UV-curable acrylic co-polymer.

### CROSS-REFERENCE TO RELATED APPLICATIONS

This application claims the benefit of priority to U.S. Patent Application No. 62/728,495, filed on Sep. 7, 2018, the contents of which are incorporated herein in their entirety.

### FIELD

The present technology is generally related to the field of flooring applications. More particularly, the technology relates to floor coverings that have a UV-curable hot melt adhesive composition applied to the back of the desired floor covering and allows the user to directly place the floor covering at the desired place after removing the protective liner covering the adhesive.

### SUMMARY

In one aspect, provided herein is an article of manufacture containing:
a floor covering element having an obverse face and a reverse face;
an adhesive layer applied to the reverse face; and
a release liner in adherence to the adhesive layer;
wherein:
   the adhesive layer contains a UV-curable hot melt adhesive composition comprising a UV-curable acrylic co-polymer derived from a (meth)acrylic co-polymer covalently bound to a compound of Formula (I), (II), or (III) through the olefinic moiety of the compound:

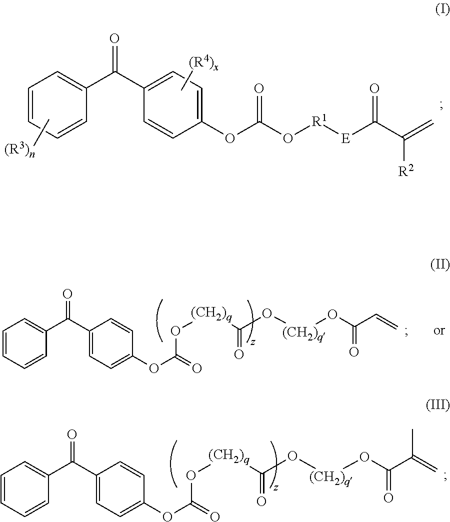

wherein:
   R¹ is a linker group;
   R² is H or alkyl;
   E is O or NR⁵;
   each R³ is individually a substituent selected from the group consisting of halogen, alkyl, O-alkyl, cycloalkyl, and an alkyl group containing a heteroatom, a halogen, a carbonyl group, alkoxy, or amino group;
   each R⁴ is individually a substituent selected from the group consisting of halogen, alkyl, O-alkyl, cycloalkyl, and an alkyl group containing a heteroatom, a halogen, a carbonyl group, alkoxy, or amino group;
   R⁵ is H or alkyl;
   n is 0-5;
   x is 0-4; and
   each of q, q′, and z are individually 1-10.

In some embodiments, R¹ is arylene, cycloalkylenyl, —[C(R⁶)(R⁷)]_{n′}—, or —{[C(R⁶)(R⁷)]_{n′}C(O)}_{x′}[O(C(R⁶)(R⁷))_{y}]ₚ—; each R⁶ is individually H, OR¹⁰, alkyl, aryl, or C(O)OH; each R⁷ is individually H, OR¹⁰, alkyl, or aryl; each R¹⁰ is individually H or alkyl; n′ is 1-12; y is 1, 2, or 3; p is 1, 2, or 3; and x′ is 1-10. In some embodiments, R¹ is —(CH₂)_{n′}—, cyclohexan-1,4-yl, phenylen-1,4-yl, —[(CH₂)₃C(O)]₂—O—(CH₂)_{y}—, —C(CH₃)(C(O)OH)—, —C(H)(phenyl)C(CH₃)(H)—, or —CH₂C(CH₃)₂CH₂—. In some embodiments, R¹ is —(CH₂)₃—; E is O; n is 0, x is 0, and R² is H or methyl.

In some embodiments, the compound of Formula (I), (II), or (III) is:

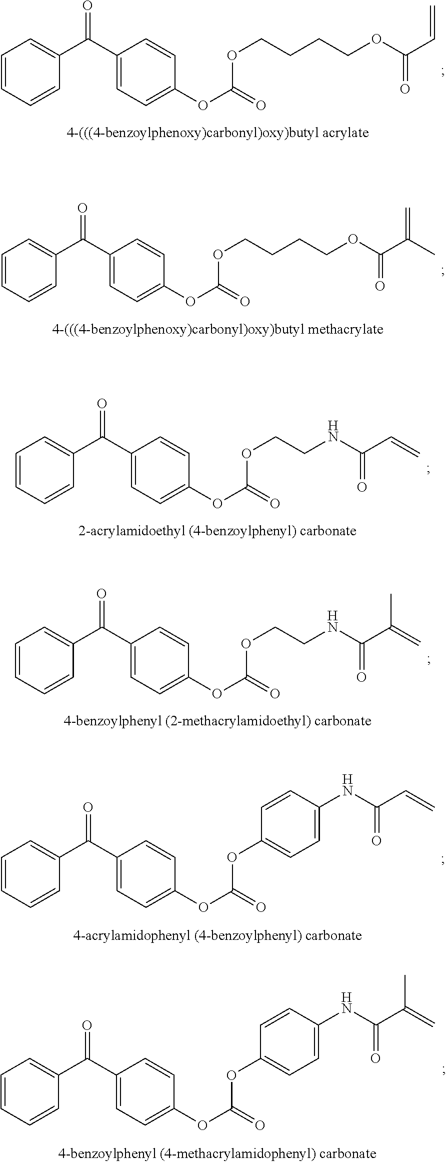 [SMILES: C=CC(=O)OCCCCOC(=O)Oc1ccc(C(=O)c2ccccc2)cc1 ; C=C(C)C(=O)OCCCCOC(=O)Oc1ccc(C(=O)c2ccccc2)cc1 ; C=CC(=O)NCCOC(=O)Oc1ccc(C(=O)c2ccccc2)cc1 ; C=C(C)C(=O)NCCOC(=O)Oc1ccc(C(=O)c2ccccc2)cc1 ; C=CC(=O)Nc1ccc(OC(=O)Oc2ccc(C(=O)c3ccccc3)cc2)cc1 ; C=C(C)C(=O)Nc1ccc(OC(=O)Oc2ccc(C(=O)c3ccccc3)cc2)cc1]

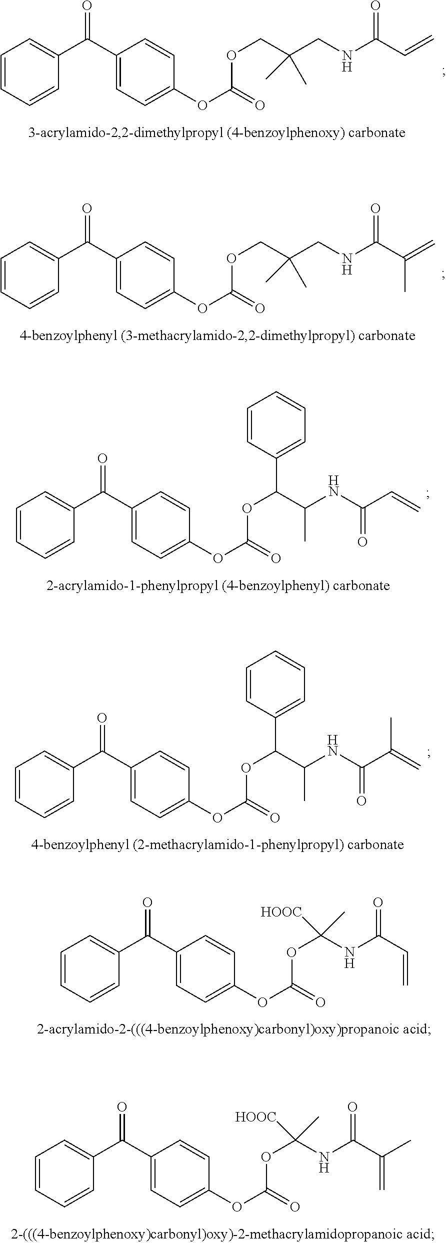 [SMILES: C=CC(=O)NCC(C)(C)COC(=O)Oc1ccc(C(=O)c2ccccc2)cc1 ; C=C(C)C(=O)NCC(C)(C)COC(=O)Oc1ccc(C(=O)c2ccccc2)cc1 ; C=CC(=O)NC(C)C(OC(=O)Oc1ccc(C(=O)c2ccccc2)cc1)c1ccccc1 ; C=C(C)C(=O)NC(C)C(OC(=O)Oc1ccc(C(=O)c2ccccc2)cc1)c1ccccc1 ; C=CC(=O)NC(C)(OC(=O)Oc1ccc(C(=O)c2ccccc2)cc1)C(=O)O ; C=C(C)C(=O)NC(C)(OC(=O)Oc1ccc(C(=O)c2ccccc2)cc1)C(=O)O]

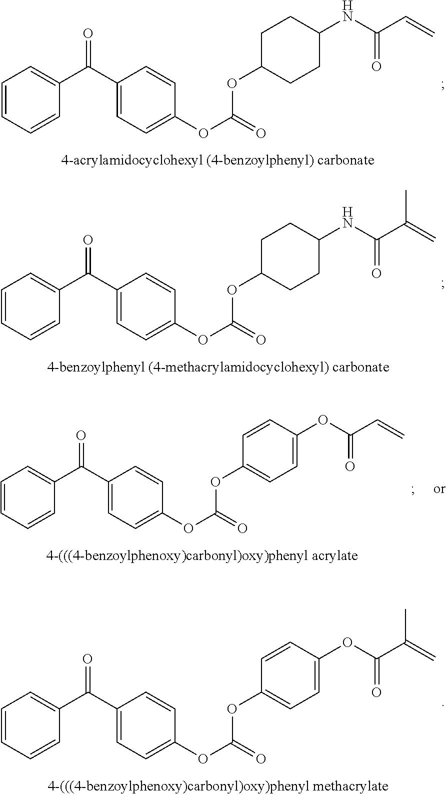 [SMILES: C=CC(=O)NC1CCC(OC(=O)Oc2ccc(C(=O)c3ccccc3)cc2)CC1 ; C=C(C)C(=O)NC1CCC(OC(=O)Oc2ccc(C(=O)c3ccccc3)cc2)CC1 ; C=CC(=O)Oc1ccc(OC(=O)Oc2ccc(C(=O)c3ccccc3)cc2)cc1 ; C=C(C)C(=O)Oc1ccc(OC(=O)Oc2ccc(C(=O)c3ccccc3)cc2)cc1]

In some embodiments, the compound of Formula (I), (II), or (III) is present from about 0.01 wt % to about 5 wt %, based on the solids of the adhesive composition. In some embodiments, the (meth)acrylic co-polymer is derived from a (meth)acrylic monomer containing acrylic acid, methacrylic acid, methylmethacrylic acid, methylmethacrylate, ethylmethacrylate, a hydroxy vinyl ether, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate, methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate, tetrahydropyranyl methacrylate, hydroxyalkyl acrylates and methacrylates, acrylic acid and its salts, acrylonitrile, acrylamide, methyl alpha-chloroacrylate, methyl 2-cyanoacrylate, N-ethylacrylamide, N,N-diethylacrylamide, acrolein, methacrylic acid and its salts, methacrylonitrile, methacrylamide, N-methylmethacrylamide, N-ethylmethacrylamide, N,N-diethylmethacrylamide, N,N-dimethylmethacrylamide, N-phenylmethacrylamide, methacrolein, or a mixture of any two or more thereof.

In some embodiments, the UV-curable acrylic polymer has a weight average molecular weight (M_{W}) is from about 30,000 g/mol to about 300,000 g/mol. In some embodiments, the weight average molecular weight (M_{W}) is from about 40,000 g/mol to about 300,000 g/mol. In some embodiments, the weight average molecular weight (M_{W}) is from about 50,000 g/mol to about 300,000 g/mol. In some embodiments, the weight average molecular weight (M_{W}) is from about 100,000 g/mol to about 300,000 g/mol.

In some embodiments, the UV-curable hot melt adhesive composition further contains an antioxidant. In some embodiments, the UV-curable hot melt adhesive composition further contains a tackifier. In some embodiments, the UV-curable hot melt adhesive composition is essentially free of solvents and volatile components.

In another aspect, provided herein is a method for preparing a floor covering element, the method containing:
heating a UV-curable hot melt adhesive composition to a molten state at a temperature from about 80° C. to about 160° C. to provide a molten UV-curable hot melt adhesive;
applying the molten UV-curable hot melt adhesive to a reverse face of the floor covering element to provide an adhesive-coated floor covering;
exposing the UV-curable hot melt adhesive on the reverse face of the floor covering to ultraviolet radiation having a wavelength of about 250 nm to about 260 nm to photoinitiate curing of the disposed UV-curable hot melt adhesive to the floor covering element to form a cured floor covering element having cured adhesive; and
applying a release liner to cured adhesive;
wherein:
   the UV-curable hot melt adhesive composition contains a UV-curable acrylic co-polymer derived from a (meth)acrylic co-polymer covalently bound to a compound of Formula (I), (II), or (III) through the olefinic moiety of the compound:

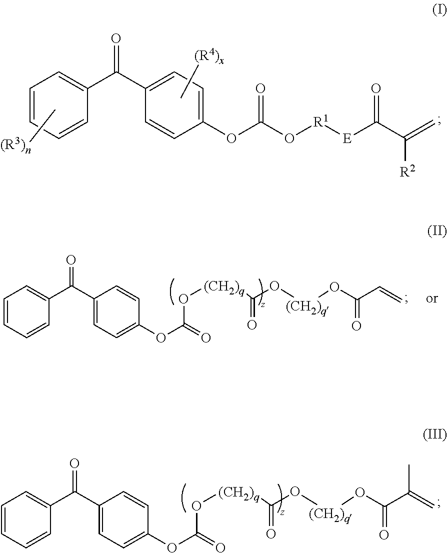

wherein:
   R¹ is a linker group;
   R² is H or alkyl;
   E is O or NR⁵;
   each R³ is individually a substituent selected from the group consisting of halogen, alkyl, O-alkyl, cycloalkyl, and an alkyl group containing a heteroatom, a halogen, a carbonyl group, alkoxy, or amino group;
   each R⁴ is individually a substituent selected from the group consisting of halogen, alkyl, O-alkyl, cycloalkyl, and an alkyl group containing a heteroatom, a halogen, a carbonyl group, alkoxy, or amino group;
   R⁵ is H or alkyl;
   n is 0-5;
   x is 0-4; and
   each of q, q′, and z are individually 1-10.

In some embodiments, the heating a UV-curable hot melt adhesive composition to a molten state is at a temperature from about 120° C. to about 160° C. to provide a molten UV-curable hot melt adhesive.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an organic group (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. The present disclosure is understood to include embodiments where, for instance a “substituted alkyl” optionally contains one or more alkene and/or alkyne. A substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); alkyl; haloalkyl (such as, but not limited to, trifluoroalkyl); hydroxyls; alkoxy, alkenoxy, alkynoxy, aryloxy, aralkyloxy, heterocyclyloxy, and heterocyclylalkoxy groups; aryl groups; heteroaryl groups; cycloalkyl groups; heterocyclyl groups; carbonyls (oxo); carboxyls; esters; urethanes; oximes; carbamates, hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

Alkyl groups include straight chain and branched alkyl groups having from 1 to about 20 carbon atoms, and typically from 1 to 12 carbons or, in some embodiments, from 1 to 8, 1 to 6, or 1 to 4 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above.

Alkoxy groups are hydroxyl groups (—OH) in which the bond to the hydrogen atom is replaced by a bond to a carbon atom of a substituted or unsubstituted alkyl group as defined above. Examples of linear alkoxy groups include but are not limited to methoxy, ethoxy, propoxy, butoxy, pentoxy, hexoxy, and the like. Examples of branched alkoxy groups include but are not limited to isopropoxy, sec-butoxy, tert-butoxy, isopentoxy, isohexoxy, and the like. Examples of cycloalkoxy groups include but are not limited to cyclopropyloxy, cyclobutyloxy, cyclopentyloxy, cyclohexyloxy, and the like. Representative substituted alkoxy groups may be substituted one or more times with substituents such as those listed above.

Aryl groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. Although the phrase “aryl groups” includes groups containing fused rings, such as fused aromatic-aliphatic ring systems (e.g., indanyl, tetrahydronaphthyl, and the like), it does not include aryl groups that have other groups, such as alkyl or halo groups, bonded to one of the ring members. Rather, groups such as tolyl are referred to as substituted aryl groups. Representative substituted aryl groups may be mono-substituted or substituted more than once. For example, monosubstituted aryl groups include, but are not limited to, 2-, 3-, 4-, 5-, or 6-substituted phenyl or naphthyl groups, which may be substituted with substituents such as those listed above. In some embodiments, an aryl group is a monoradical or a diradical (i.e., an arylene group).

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 3 to 6, or 3 to 7. Substituted cycloalkyl groups may be substituted one or more times with non-hydrogen and non-carbon groups as defined above. However, substituted cycloalkyl groups also include rings that are substituted with straight or branched chain alkyl groups as defined above. Representative substituted cycloalkyl groups may be mono-substituted or substituted more than once, such as, but not limited to, 2,2-, 2,3-, 2,4-2,5- or 2,6-di-substituted cyclohexyl groups, which may be substituted with substituents such as those listed above. In some embodiments, a cycloalkyl group has one or more alkene bonds, but is not aromatic, such as a cycloalkylenyl group.

The term “UV-curable acrylic co-polymer refers to a radiation curable co-polymer derived from a (meth)acrylic co-polymer covalently bound to a photoreactive group. Mixtures or blends with other acrylic polymers may be used. In some embodiments, the UV-curable acrylic co-polymer contains an (meth)acrylic co-polymer backbone molecule that is modified with polymerized photoreactive groups, e.g., a modified benzophenone group that is chemically bonded to the acrylic polymer chain. The polymer is crosslinked by chemical grafting caused by the excitation of the photoinitiator by UV irradiation.

The term “UV-curable adhesive” as used herein means an adhesive composition which is curable upon exposure to actinic and/or ionizing radiation. The term “radiation” is used herein to include actinic radiation such as ultraviolet radiation and ionizing radiation created by the emission of electrons or highly accelerated nuclear particles such as neutrons, alpha-particles etc.

The term “(meth)acrylic” or “(meth)acrylate” refers to acrylic or methacrylic acid, esters of acrylic or methacrylic acid, and salts, amides, and other suitable derivatives of acrylic or methacrylic acid, and mixtures thereof.

Provided in one aspect are UV-curable hot melt adhesive compositions suitable for use in flooring application. In some embodiments, these UV-curable hot melt compositions described herein are on the back of the desired floor covering, such as carpet, carpet tiles, luxury vinyl tiles (LVT), luxury modular floors (LMF), vinyl tiles, flexible floor tiles, rigid floor tiles, and ceramic tiles and have a protective release liner covering the adhesive to prevent premature application. This allows the user to remove the protective release liner covering the adhesive and install the desired floor covering to the desired place-“peel and stick flooring.” This “peel and stick” flooring approach allows for the immediate use of the floor covering, avoids the drying time required with using solvent or water based adhesives, avoids the generation of volatile organic chemical (VOC) emissions, reduces time required for installation, has improved plasticizer and high temperature resistance over hot melt adhesives.

In another aspect, an article of manufacture is provided containing: a floor covering element having an obverse face and a reverse face; an adhesive layer applied to the reverse face; and a release liner in adherence to the adhesive layer; wherein: the adhesive layer contains a UV-curable hot melt adhesive composition containing a UV-curable acrylic co-polymer derived from a (meth)acrylic co-polymer covalently bound to a compound of Formula (I), (II), or (III) as described herein through the olefinic moiety of the compound.

The UV-curable hot melt adhesive composition described herein is particularly suitable as an adhesive for bonding substrates made from plastic, wood, metal and textiles formed from woven and/or nonwoven fibers. In some embodiments, the adhesive composition is particularly suitable as a flooring adhesive, especially for bonding floor coverings to substrates made from wood, plastic or, in particular, mineral substrates, such as screeding concrete or ceramic tiles.

In some embodiments, the adhesive composition is especially suitable as a flooring adhesive for carpets or other floor coverings made, for example, from PVC (in configurations as multilayer coverings or homogeneous coverings), foam coverings with a textile backing (e.g., jute), polyester nonwoven, rubber coverings, textile coverings with, for example, various backings (such as polyurethane foam, styrene-butadiene foam, or a textile secondary backing), needlefelt floor coverings, polyolefin coverings or linoleum coverings, on substrates such as wood, screeding, concrete, ceramic tiles, metal substrates or the like.

### Floor Covering Elements

The adhesive composition may be utilized to secure a wide variety of floor covering elements to a sub-floor. Without limitation, the adhesive composition may be utilized to adhesively secure wooden floor covering elements, luxury modular floor (LMF), luxury vinyl tile (LVT), vinyl floor coverings (VCT), ceramic, and like floor coverings. According to a certain illustrative embodiment, the adhesive composition may be utilized to adhesively bond a plurality of wooden floor covering elements to a floor substrate. Without limitation, the wooden floor elements include wooden parquet pieces, engineered wood plank, acrylic impregnated plank, prefinished and unfinished fiat milled solids and shorts, bamboo and other exotic wood species.

The floor covering elements may also include low weight bonded flooring material or item, such as, a carpet tile, broadloom carpet, wall to wall carpet, an area rug, carpet, rug, runner, mat, broadloom, or the like.

The floor covering element has an obverse face and a reverse face. In some embodiments, the adhesive layer is applied to the reverse face of the floor covering element. In some embodiments, the release liner is applied in adherence to the adhesive layer.

### Floor or Sub-Floor Substrates

The floor covering elements may be bonded to a wide variety of different base sub-floor substrates. Without limitation, for example, the floor covering elements maybe adhesively bonded to plywood sheathing, oriented strand board, particle board, wafer board, cork underlayments, existing vinyl tile and sheet flooring, cementitious underlayments, concrete, masonry, terrazzo, anhydrous underlayments, radiant heat subfloors where temperatures do not exceed about 85° F., and like flooring substrates. According to certain embodiments, the floor covering elements comprise wooden parquet pieces, carpet tile, ceramic tile, luxury vinyl tile, luxury modular floor that are adhesively bonded to a wooden sub-floor with the adhesive composition.

In one aspect provided herein a method for constructing a floor is described using the UV-curable hot melt adhesive composition in combination with floor covering elements. The method may include applying the UV-curable hot melt adhesive composition to at least a portion of the surface of the flooring substrate and applying the floor covering elements to the layer of adhesive on the surface of the flooring substrate.

### Release Liner

The release liner may include a polymeric film or extrudate, or in other embodiments it may include a cellulosic substrate. Where the polymeric film and/or cellulosic substrate cannot be readily removed after being attached to the adhesive layer component, the polymeric film and/or cellulosic substrate can carry a coating or layer that allows the polymeric film and/or cellulosic substrate to be readily removed from the adhesive component after attachment. This polymeric film or extrudate may include a single polymeric layer or may include two or more polymeric layers laminated or coextruded to one another.

Suitable materials for forming a release liner is a polymeric film or extrudate include polypropylene, polyester, high-density polyethylene, medium-density polyethylene, low-density polyethylene, polystyrene, high-impact polystyrene, silicone release coatings applied over a polymeric film, and the like. The coating, or layer applied to the film and/or cellulosic substrate, may include a silicon-containing or fluorine-containing coating. For example, a silicone oil or polysiloxane may be applied as a coating. In other embodiments, hydrocarbon waxes may be applied as a coating. The release liner can be applied to both planar surfaces of the film and/or cellulosic substrate. In other embodiments, the release liner need only be applied to the planar surface of the film and/or cellulosic substrate that is ultimately removably mated with the floor covering element.

In one or more embodiments, the release liner is characterized by a thickness of from about 15 to about 80 microns. This may include from about 18 to about 75 microns, or about 20 to about 50 microns. In some embodiments, the release layer is characterized by a thickness of about 15 microns, about 20 microns, about 25 microns, about 30 microns, about 35 microns, about 40 microns, about 45 microns, about 50 microns, about 55 microns, about 60 microns, about 65 microns, about 70 microns, about 75 microns, or about 80 microns.

### UV-Curable Hot Melt Adhesive Composition

In another aspect, a UV-curable hot melt adhesive composition is provided containing a (meth)acrylic co-polymer. In some embodiments, the adhesive composition may also comprise a photoinitiator, wherein the photoinitiator is covalently bound to the (meth)acrylic co-polymer.

Examples of suitable photoinitiators which may be used include one or more of the following: benzophenone, benzyldimethyl ketal, isopropylthioxanthone, bis(2,6-dimethoxybenzoyl)(2,4,4-trimethylpentyl)phosphineoxide, 2-hydroxy-2-methyl-1-phenyl-1-propanone, diphenyl(2,4,6-trimethybenzoyl)phosphine oxides, 1-hydroxycyclohexyl phenyl ketone, 2-benzyl-2-(dimethylamino)-1-4-(4-morpholinyl)phenyl-1-butanone, α,α-dimethoxy-α-phenylacetophenone, 2,2-diethoxyacetophenone, 2-methyl-1-4-(methylthio)phenyl-2-(4-morpholinyl)-1-propanone, 2-hydroxy-1-4-(hydroxyethoxy)phenyl-2-methyl-1-propanone.

The UV-curable acrylic co-polymer may be a radiation curable co-polymer derived from a (meth)acrylic co-polymer covalently bound to photoreactive group. Mixtures or blends with other acrylic polymers may be used. In some embodiments, the UV-curable acrylic co-polymer contains an (meth)acrylic co-polymer backbone molecule that is modified with polymerized photoreactive groups, e.g., a modified benzophenone group that is chemically bonded to the acrylic polymer chain. In some embodiments, the polymer is crosslinked by chemical grafting caused by the excitation of the photoinitiator by UV irradiation.

In some embodiments, the adhesive composition described herein contains from about 50 wt % to about 100 wt % of the UV-curable acrylic co-polymer. In some embodiments, the adhesive composition described herein contains about 50 wt %, about 55 wt %, about 60 wt %, about 65 wt %, about 70 wt %, about 75 wt %, about 80 wt %, about 85 wt %, about 90 wt %, about 95 wt %, or about 100 wt % of the UV-curable acrylic co-polymer.

In yet another aspect, a UV-curable hot melt adhesive composition is provided containing a UV-curable acrylic co-polymer derived from a (meth)acrylic co-polymer covalently bound to a compound of Formula (I), (II), or (III) as described herein through the olefinic moiety of the compound.

The (meth)acrylic co-polymer may be derived from a (meth)acrylic monomer containing acrylic acid, methacrylic acid, methylmethacrylic acid, methylmethacrylate, ethylmethacrylate, a hydroxy vinyl ether, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate, methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate, tetrahydropyranyl methacrylate, hydroxyalkyl acrylates and methacrylates, acrylic acid and its salts, acrylonitrile, acrylamide, methyl alpha-chloroacrylate, methyl 2-cyanoacrylate, N-ethylacrylamide, N,N-diethylacrylamide, acrolein, methacrylic acid and its salts, methacrylonitrile, methacrylamide, N-methylmethacrylamide, N-ethylmethacrylamide, N,N-diethylmethacrylamide, N,N-dimethylmethacrylamide, N-phenylmethacrylamide, methacrolein, or a mixture of any two or more thereof.

The compounds of Formula (I), (II), and (III) are polymerizable photoinitiators of the following structures:

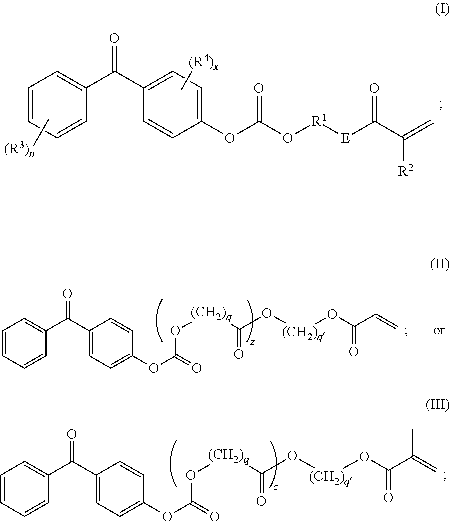

wherein:
   R¹ is a linker group;
   R² is H or alkyl;
   E is O or NR⁵;
   each R³ is individually a substituent selected from the group consisting of halogen, alkyl, O-alkyl, cycloalkyl, and an alkyl group containing a heteroatom, a halogen, a carbonyl group, alkoxy, or amino group;
   each R⁴ is individually a substituent selected from the group consisting of halogen, alkyl, O-alkyl, cycloalkyl, and an alkyl group containing a heteroatom, a halogen, a carbonyl group, alkoxy, or amino group;
   R⁵ is H or alkyl;
   n is 0-5;
   x is 0-4; and
   each of q, q′, and z are individually 1-10.

In some embodiments, R¹ is arylene, cycloalkylenyl, —[C(R⁶)(R⁷)]_{n′}—, or —{[C(R⁶)(R⁷)]_{n′}C(O)}_{x′}[O(C(R⁶)(R⁷))_{y}]ₚ—; each R⁶ is individually H, OR¹⁰, alkyl, C(O)OH, or aryl; each R⁷ is individually H, OR¹⁰, alkyl, or aryl; each R¹⁰ is individually H or alkyl; n′ is 1-12; y is 1, 2, or 3; p is 1, 2, or 3; and x′ is 1-10.

In some embodiments, R¹ is —(CH₂)_{n′}—, cyclohexan-1,4-yl, phenylen-1,4-yl, —[(CH₂)₃C(O)]₂—O—(CH₂)_{y}—, —C(CH₃)(C(O)OH)—, —C(H)(phenyl)C(CH₃)(H)—, or —CH₂C(CH₃)₂CH₂—. In some embodiments, R¹ is —(CH₂)₃—; E is O; n is 0, x is 0, and R² is H or methyl.

In some embodiments, the compound of Formula (I), (II), or (III) is:

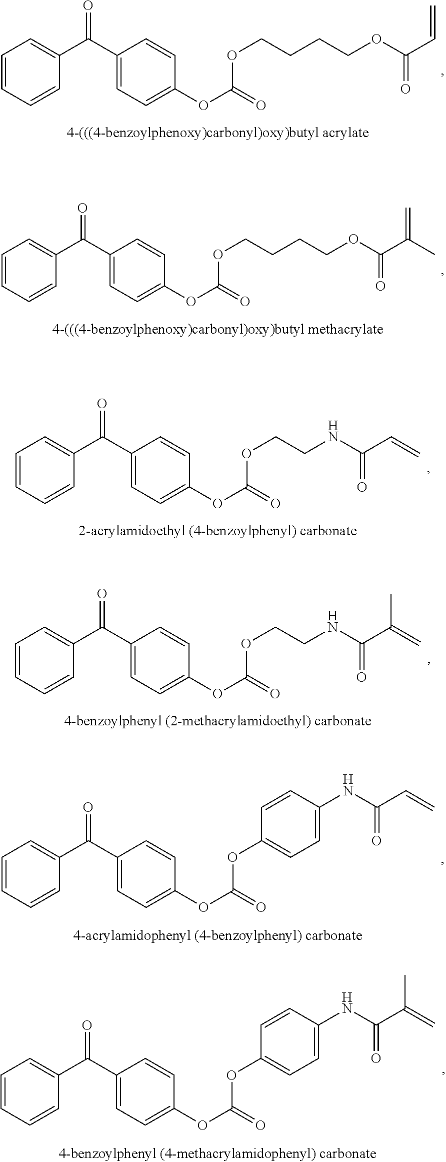 [SMILES: C=CC(=O)OCCCCOC(=O)Oc1ccc(C(=O)c2ccccc2)cc1 ; C=C(C)C(=O)OCCCCOC(=O)Oc1ccc(C(=O)c2ccccc2)cc1 ; C=CC(=O)NCCOC(=O)Oc1ccc(C(=O)c2ccccc2)cc1 ; C=C(C)C(=O)NCCOC(=O)Oc1ccc(C(=O)c2ccccc2)cc1 ; C=CC(=O)Nc1ccc(OC(=O)Oc2ccc(C(=O)c3ccccc3)cc2)cc1 ; C=C(C)C(=O)Nc1ccc(OC(=O)Oc2ccc(C(=O)c3ccccc3)cc2)cc1]

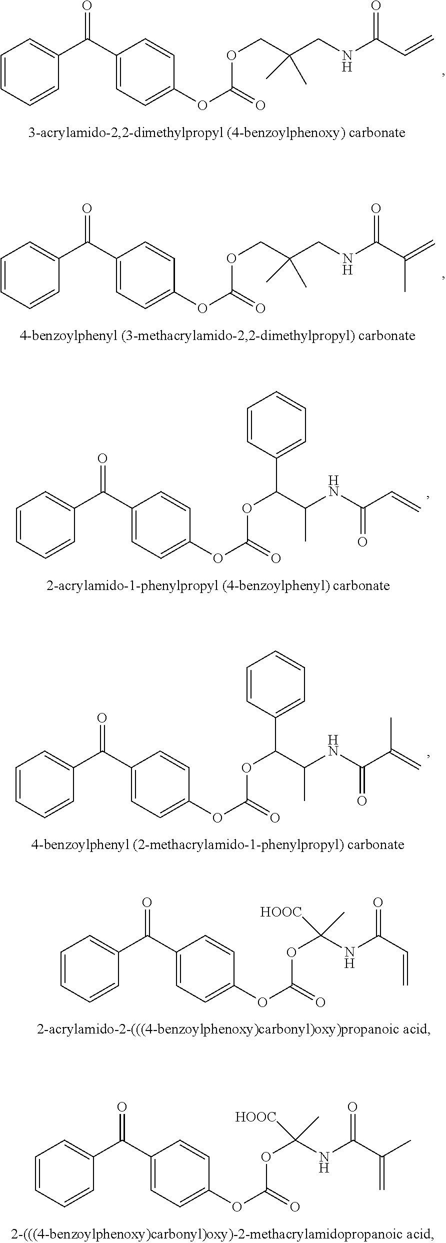 [SMILES: C=CC(=O)NCC(C)(C)COC(=O)Oc1ccc(C(=O)c2ccccc2)cc1 ; C=C(C)C(=O)NCC(C)(C)COC(=O)Oc1ccc(C(=O)c2ccccc2)cc1 ; C=CC(=O)NC(C)C(OC(=O)Oc1ccc(C(=O)c2ccccc2)cc1)c1ccccc1 ; C=C(C)C(=O)NC(C)C(OC(=O)Oc1ccc(C(=O)c2ccccc2)cc1)c1ccccc1 ; C=CC(=O)NC(C)(OC(=O)Oc1ccc(C(=O)c2ccccc2)cc1)C(=O)O ; C=C(C)C(=O)NC(C)(OC(=O)Oc1ccc(C(=O)c2ccccc2)cc1)C(=O)O]

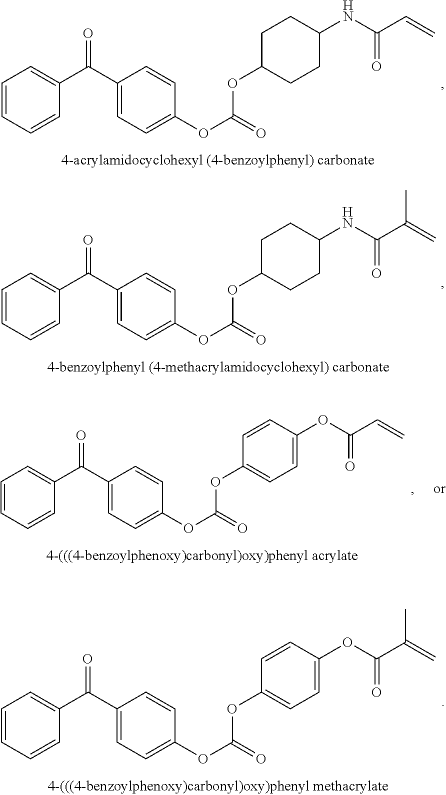 [SMILES: C=CC(=O)NC1CCC(OC(=O)Oc2ccc(C(=O)c3ccccc3)cc2)CC1 ; C=C(C)C(=O)NC1CCC(OC(=O)Oc2ccc(C(=O)c3ccccc3)cc2)CC1 ; C=CC(=O)Oc1ccc(OC(=O)Oc2ccc(C(=O)c3ccccc3)cc2)cc1 ; C=C(C)C(=O)Oc1ccc(OC(=O)Oc2ccc(C(=O)c3ccccc3)cc2)cc1]

The compound of Formula (I), (II), or (III) may be present from about 0.01 wt % to about 5.0 wt %, based upon the solids of the adhesive composition. In some embodiments, the compound of Formula (I), (II), or (III) is present from about 0.1 wt % to about 5.0 wt %, based upon the solids of the adhesive composition. In some embodiments, the compounds of Formula (I), (II), or (III) is present from about 0.1 wt % to about 3.0 wt %, based upon the solids of the adhesive composition. In some embodiments, the compounds of Formula (I), (II), and/or (III) is present from about 0.4 wt % to about 3.0 wt %, based upon the solids of the adhesive composition. In some embodiments, the compounds of Formula (I), (II), or (III) is present from about 0.4 wt % to about 2.0 wt %, based upon the solids of the adhesive composition. In some embodiments, the compound of Formula (I), (II), or (III) is present in about 0.01 wt %, about 0.05 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.5 wt %, about 2.0 wt %, about 2.5 wt %, about 3.0 wt %, about 3.5 wt %, about 4.0 wt %, about 4.5 wt %, or about 5.0 wt %, based upon the solids of the adhesive composition.

In some embodiments, the adhesive composition is essentially free of solvents and volatile components. As used herein, “essentially free” refers to less than about 5 wt %, less than about 4 wt %, less than about 3 wt %, less than about 2 wt %, less than about 1 wt %, less than about 0.5 wt %, less than about 0.1 wt %, less than about 0.05 wt %, less than about 0.01 wt %, or free of detectable amounts of organic solvents and volatile components. Such solvents include, but are not limited to, hydrocarbon solvents (aliphatic and aromatic), oxygenated solvents (alcohols, ketones, aldehydes, glycol ethers, esters, glycol ether esters), halogenated solvents (chlorinated and brominated hydrocarbons), water, and mixtures of two or more.

Solvent or substance volatility is quantified by the tendency of the solvent or substance to vaporize. Volatility is directly related to a substance's vapor pressure. At a given temperature, a substance with higher vapor pressure vaporizes more readily than a substance with a lower vapor pressure.

In some embodiments, the adhesive composition contains one or more solvents or volatile compounds in no more than about 2% by weight based on the total adhesive composition. In some embodiments, the adhesive composition contains one or more solvents or volatile compounds in about 0% to about 2%, about 0% to about 1%, or about 0% to about 0.5% by weight based on the total adhesive composition. In some embodiments, the adhesive composition contains one or more solvents or volatile compounds in less than about 2%, less than about 1%, less than about 0.5%, less than about 0.1% by weight based on the total adhesive composition.

### Co-Polymer Characteristics

The co-polymers described herein may be characterized by the weight average molecular weight (M_{w}) or number average molecular weight (Mₘ). The weight average molecular weight (M_{w}) is defined by:

M_{w}=(ΣNiMi²)/ΣNi.

In some embodiments, the co-polymer has a weight average molecular weight (M_{W}) of from about 30,000 g/mol to about 300,000 g/mol. In some embodiments, the weight average molecular weight (M_{W}) is from about 40,000 g/mol to about 300,000 g/mol. In some embodiments, the weight average molecular weight (M_{W}) is from about 50,000 g/mol to about 300,000 g/mol. In some embodiments, the weight average molecular weight (M_{W}) is from about 100,000 g/mol to about 300,000 g/mol. In some embodiments, the co-polymer has a weight average molecular weight (M_{W}) of about 30,000 g/mol, about 40,000 g/mol, about 50,000 g/mol, about 60,000 g/mol, about 70,000 g/mol, about 80,000 g/mol, about 90,000 g/mol, about 100,000 g/mol, about 125,000 g/mol, about 150,000 g/mol, about 175,000 g/mol, about 200,000 g/mol, about 225,000 g/mol, about 250,000 g/mol, about 270,000 g/mol, or about 300,000 g/mol.

The number average molecular weight (Mₙ) is the statistical average molecular weight of all the polymer chains in the polymer and is defined by:

Mₙ=(ΣNiMi)/ΣNi,

where Mi is the molecular weight of a chain and Ni is the number of chains of that molecular weight. Compared to Mₙ, M_{w} takes into account the molecular weight of a chain in determining contributions to the molecular weight average. The more massive the chain, the more the chain contributes to M_{w}.

In some embodiments, the co-polymer has a number average molecular weight of from about 5,000 g/mol to about 100,000 g/mol. In some embodiments, the co-polymer has a number average molecular weight of from about 8,000 g/mol to about 75,000 g/mol. In some embodiments, the co-polymer has a number average molecular weight of from about 10,000 g/mol to about 50,000 g/mol. In some embodiments, the co-polymer has a number average molecular weight of from about 10,000 g/mol to about 30,000 g/mol. In some embodiments, the co-polymer has a number average molecular weight of about 5,000 g/mol, about 6,000 g/mol, about 7,000 g/mol, about 8,000 g/mol, about 9,000 g/mol, about 10,000 g/mol, about 20,000 g/mol, about 30,000 g/mol, about 40,000 g/mol, about 50,000 g/mol, about 60,000 g/mol, about 70,000 g/mol, about 80,000 g/mol, about 90,000 g/mol, or about 100,000 g/mol.

Also, the co-polymers described herein may be characterized by dispersity index or polydispersity index (PDI), which is a measure of the distribution of molecular mass in a given polymer sample. PDI of a polymer is calculated:

PDI=M_{w}/Mₙ,

where the weight average molecular weight and the statistical average molecular weight are defined above.

In some embodiments, the co-polymer has a K value of from about 10 to about 150 or from about 15 to about 100. In some embodiments, the co-polymer has a K value of from about 25 to about 55, from about 60 to about 100, or from about 15 to about 85. In some embodiments, the co-polymer has a K value of about 10, about 15, about 20, about 25, about 30, about 35, about 40, about 45, about 50, about 55, about 60, about 65, about 70, about 75, about 80, about 85, about 90, about 95, about 100, about 105, about 110, about 115, about 120, about 125, about 130, about 135, about 140, about 145, or about 150. Determination of the K value is carried out, usually at 25° C. according to DIN ISO 1628-1, on a 1 wt % strength solution of the co-polymer in tetrahydrofuran.

The co-polymers described herein may exhibit glass transition temperatures of from about −70° C. to about 150° C. In some embodiments, the glass transition temperature is from about −70° C. to about +30° C. In some embodiments, the glass transition temperature is from about −70° C. to about <+10° C., from about −50° C. to about ≤+5° C., or from about −50° C. to about ≤0° C.

By the glass transition temperature Tg, it is meant the limiting value of the glass transition temperature which it approaches with increasing molecular weight as described by G. Kanig (Kolloid-zeitschrift & Zeitschrift fr Polymere, Vol. 190, page 1, equation 1). The glass transition temperature is determined by the DSC method (Differential Scanning Calorimetry, 20 K/min, mid-point reading, DIN 53,765).

According to Fox (T. G. Fox, Bull. Am. Phys. Soc. 1956 [Ser. II] 1, page 123 and according to Ullmanns Encyclopaedie der technischen Chemie, Vol. 19, page 18, 4th Edition, Verlag Chemie, Weinheim, 1980) the following applies to the glass transition temperature of not more than weakly crosslinked co-polymers, as a good approximation:

1/Tg=x¹/Tg¹+x²/Tg²+ . . . xⁿ/Tgⁿ,

in which x¹, x² . . . xⁿ denote the mass fractions of the monomers 1, 2 . . . n and Tg¹, Tg² . . . Tgⁿ denote the glass transition temperatures of the polymers composed of, in each case, only one of the monomers 1, 2 . . . n, in degrees Kelvin. The Tg values for the homopolymers of most monomers are known and are listed, for example, in Ullmann's Encyclopedia of Industrial Chemistry, Vol. 5, Vol. A21, page 169, VCH Weinheim, 1992; further sources of glass transition temperatures of homopolymers are, e.g., J. Brandrup, E. H. Immergut, Polymer Handbook, 1.sup.st Ed., J. Wiley, New York 1966, 2.sup.nd Ed. J. Wiley, New York 1975, and 3rd Ed. J. Wiley, New York 1989).

### Additional Adhesive Components

The adhesive compositions described herein may include other additives to provide other desirable properties to the adhesives. These additives may include, but are not limited to, pigments, fillers, fluorescent additives, flow and leveling additives, wetting agents, surfactants, antifoaming agents, rheology modifiers, stabilizers, and antioxidants. Other optional additives include unsaturated oligomers and multifunctional monomers containing acrylate or methacrylate functionality, such as SR 295, SR 355 and SR 350 available from Sartomer, and additional photoinitiators. Preferred additives are those which do not have appreciable absorption in the UVC wavelengths of interest (250-260 nm).

In some embodiments, the adhesive compositions described herein may further comprise an antioxidant. Antioxidants are added to protect the ingredients against degradation during preparation and use of the adhesive compositions and to ensure long-term thermal stability, however without interfering with the irradiation curing of the polymer.

Combinations of antioxidants are often more effective due to the different mechanisms of degradation to which various polymers are subject. Certain hindered phenols, organometallic compounds, aromatic amines, aromatic phosphites, and sulfur compounds are useful for this purpose. Examples of effective types of these materials include phenolic antioxidants, thio compounds, and tris(nonylated phenyl)phosphites.

In some embodiments, the adhesive composition contains no greater than about 3% by weight of one or more antioxidants. In some embodiments, the adhesive composition contains from about 0% to about 3%, from about 0.1% to about 3%, about 0% to about 2%, from about 0.1% to about 2%, or from about 0.4% to about 2.0% by weight of one or more antioxidants.

In some embodiments, the antioxidant is a phenolic antioxidant. In some embodiments, the phenolic antioxidant includes an alkylated monophenol. Illustrative examples include, but are not limited to, 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(alpha-methylcyclohexyl)-4,6-dimethylphenol, 2,6-dioctadecyl-4-methylphenol, 2,4,6-tricyclohexylphenol, and 2,6-di-tert-butyl-4-methoxymethylphenol. In some embodiments, the alkylated monophenol is a nonylphenol, which is linear or branched in the side chains. Some non-limiting examples of a nonylphenol include, but are not limited to, 2,6-di-nonyl-4-methylphenol, 2,4-dimethyl-6-(1-methylundec-1-yl)phenol, 2,4-dimethyl-6-(1-methylheptadec-1-yl)phenol, 2,4-dimethyl-6-(1-methyltridec-1-yl)phenol and mixtures thereof.

In some embodiments, the phenolic antioxidant is an alkylthiomethylphenol. Illustrative examples include, but are not limited to, 2,4-dioctylthiomethyl-6-tert-butylphenol, 2,4-dioctylthiomethyl-6-methylphenol, 2,4-dioctylthiomethyl-6-ethylphenol, and 2,6-di-dodecylthiomethyl-4-nonylphenol.

In some embodiments, the phenolic antioxidant is a hydroquinones or an alkylated hydroquinone. Illustrative examples include but are not limited to 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, and bis-(3,5-di-tert-butyl-4-hydroxyphenyl) adipate.

In some embodiments, the phenolic antioxidant is a tocopherol. Illustrative examples include, but are not limited to, alpha-tocopherol, beta-tocopherol, gamma-tocopherol, delta-tocopherol and mixtures thereof (Vitamin E).

In some embodiments, the phenolic antioxidant is a hydroxylated thiodiphenyl ether. Illustrative examples include, but are not limited to, 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis-(3,6-di-sec-amylphenol), and 4,4′-bis(2,6-dimethyl-4-hydroxyphenyl)disulfide.

In some embodiments, the phenolic antioxidant is an alkylidenebisphenol. Examples of alkylidenebisphenols include, but are not limited to, 2,2′-methylenebis(6-tert-butyl-4-methylphenol), 2,2′-methylenebis(6-tert-butyl-4-ethylphenol), 2,2′-methylenebis[4-methyl-6-(□-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis [6-(alpha-methylbenzyl)-4-nonylphenol], 2,2′-methylenebis[6-(alpha, alpha-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3-tert-butyl-4-hydroxyphenyl)butyrate], bis(3-tert-butyl-4-hydroxy-5-methyl-phenyl)dicyclopentadiene, bis[2-(3′tert-butyl-2-hydroxy-5-methylbenzyl)-6-tert-butyl-4-methylphenyl]terephthalate, 1,1-bis-(3,5-dimethyl-2-hydroxyphenyl)butane, 2,2-bis-(3,5-di-tert-butyl-4-hydroxyphenyl)propane, 2,2-bis-(5-tert-butyl-4-hydroxy2-methylphenyl)-4-n-dodecylmercaptobutane, and 1,1,5,5-tetra-(5-tert-butyl-4-hydroxy-2-methylphenyl)pentane.

In some embodiments, the phenolic antioxidant is a benzyl compound. Some examples of benzyl compounds include, but are not limited to, 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, 1,3,5-tri-(3,5-di-tert-butyl-4-hydroxybenzyl)-2,4,6-trimethylbenzene, di-(3,5-di-tert-butyl-4-hydroxybenzyl) sulfide, 3,5-di-tert-butyl-4-hydroxybenzyl-mercapto-acetic acid isooctyl ester, bis-(4-tert-butyl-3-hydroxy-2,6-dimethylbenzyl)dithiol terephthalate, 1,3,5-tris-(3,5-di-tert-butyl-4-hydroxybenzyl) isocyanurate, 1,3,5-tris-(4-tert-butyl-3-hydroxy-2,6-dimethylbenzyl) isocyanurate, 3,5-di-tert-butyl-4-hydroxybenzyl-phosphoric acid dioctadecyl ester and the calcium salt of 3,5-di-tert-butyl-4-hydroxybenzyl-phosphoric acid monoethyl ester.

In some embodiments, the phenolic antioxidant is a hydroxybenzylated malonate. Illustrative examples include, but are not limited to, dioctadecyl-2,2-bis-(3,5-di-tert-butyl-2-hydroxybenzyl)-malonate, di-octadecyl-2-(3-tert-butyl-4-hydroxy-5-methylbenzyl)-malonate, di-dodecylmercaptoethyl-2,2-bis-(3,5-di-tert-butyl-4-hydroxybenzyl)malonate, and bis[4-(1,1,3,3-tetramethylbutyl)phenyl]-2,2-bis(3,5-di-tert-butyl-4-hydroxybenzyl)malonate.

In some embodiments, the phenolic antioxidant is an aromatic hydroxybenzyl compound. Illustrative examples include, but are not limited to, 1,3,5-tris-(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, and 2,4,6-tris(3,5-di-tert-butyl-4-hydroxybenzyl)phenol.

In some embodiments, the phenolic antioxidant is a triazine compound. Illustrative examples include, but are not limited to, 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris-(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, and 1,3,5-tris(3,5-dicyclohexyl-4-hydroxybenzyl)isocyanurate.

In some embodiments, the phenolic antioxidant is a benzylphosphonate. Illustrative examples include, but are not limited to, dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

In some embodiments, the phenolic antioxidant is an acylaminophenol. Illustrative examples include, but are not limited to, 4-hydroxy-lauric acid anilide, 4-hydroxy-stearic acid anilide, 2,4-bis-octylmercapto-6-(3,5-tert-butyl-4-hydroxyanilino)-s-triazine and octyl-N-(3,5-di-tert-butyl-4-hydroxyphenyl)-carbamate.

In some embodiments, the phenolic antioxidant is an ester of beta-(3,5-di-tert-butyl-4-hydroxyphenyl)propionic acid with mono- or poly-hydric alcohol, an ester of beta-(5-tert-butyl-4-hydroxy-3-methylphenyl)propionic acid with mono- or poly-hydric alcohol, an ester of beta-(3,5-dicyclohexyl-4-hydroxyphenyl)propionic acid with mono- or poly-hydric alcohol, or an ester of 3,5-di-tert-butyl-4-hydroxyphenyl acetic acid with mono- or poly-hydric alcohol. Examples of mono- or poly-hydric alcohols include, but are not limited to, methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxamide, 3-thiaundecanol, 3-thiapentadecanol, trimethylhexanediol, trimethylolpropane, and 4-hydroxymethyl-1-phospha-2,6,7-trioxabicyclo[2.2.2]octane.

In some embodiments, the phenolic antioxidant is an amide of beta-(3,5-di-tert-butyl-4-hydroxyphenyl)propionic acid. Illustrative examples include, but are not limited to, N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl) hydrazide, and N,N′-bis[2-(3-[3,5-di-tert-butyl-4-hydroxyphenyl]propionyloxy)ethyl]oxamide (Naugard®XL-1 supplied by Uniroyal).

In some embodiments, the phenolic antioxidant includes, but is not limited to: n-octadecyl 3,5-di-tert-butyl-4-hydroxyhydrocinnamate; neopentanetetrayl tetrakis(3,5-di-tert-butyl-4-hydroxyhydrocinammate; di-n-octadecyl 3,5-di-tert-butyl-4-hydroxybenzylphosphonate; 1,3,5-tris(3,5-di-tert-butyl-4-hydroxybenzyl)isocyanurate; thiodiethylene bis(3,5-di-tert-butyl-4-hydroxyhydrocinnamate); 1,3,5-trimethyl-2,4,6-tris(3,5-di-tert-butyl-4-hydroxybenzyl)benzene; 3,6-dioxaoctamethylene bis(3-methyl-5-tert-butyl-4-hydroxyhydrocinnamate; 2,6-di-tert-butyl-p-cresol; 2,2′-ethylidene-bis(4,6-di-tert-butylphenol); 1,3,5-tris(2,6-dimethyl-4-tert-butyl-3-hydroxybenzyl)isocyanurate; 1,1,3,-tris(2-methyl-4-hydroxy-5-tert-butylphenyl)butane; 1,3,5-tris[2-(3,5-di-tert-butyl-4-hydroxyhydrocinnamoyloxy)ethyl] isocyanurate; 3,5-di-(3,5-di-tert-butyl-4-hydroxybenzyl)mesitol; hexamethylene bis(3,5-di-tert-butyl-4-hydroxyhydrocinnamate); 1-(3,5-di-tert-butyl-4-hydroxyanilino)-3,5-di(octylthio)-s-triazine; N,N′-hexamethylene-bis(3,5-di-tert-butyl-4-hydroxyhydrocinnamamide); calcium bis(ethyl 3,5-di-tert-butyl-4-hydroxybenzylphosphonate); ethylene bis[3,3-di(3-tert-butyl-4-hydroxyphenyl)butyrate]; octyl 3,5-di-tert-butyl-4-hydroxybenzylmercaptoacetate; bis(3,5-di-tert-butyl-4-hydroxyhydrocinnamoyl)hydrazide; N,N-di-(C₁₂-C₂₄alkyl)-N-methyl-amine oxide; and N,N-dialkylhydroxylamine prepared from di(hydrogenated tallow)amine by direct oxidation.

In some embodiments, the adhesive compositions described herein further comprise a photoinitiator. Examples of suitable photoinitiators which may be used include one or more of the following: benzophenone, benzyldimethyl ketal, Isopropylthioxanthone, bis(2,6-dimethoxybenzoyl)(2,4,4-trimethylpentyl)phosphineoxide, 2-hydroxy-2-methyl-1-phenyl-1-propanone, diphenyl(2,4,6-trimethybenzoyl)phosphine oxides, 1-hydroxycyclohexyl phenyl ketone, 2-benzyl-2-(dimethylamino)-1-4-(4-morpholinyl)phenyl-1-butanone, alpha,alpha.-dimethoxy-alpha-phenylacetophenone, 2,2-diethoxyacetophenone, 2-methyl-1-4-(methylthio)phenyl-2-(4-morpholinyl)-1-propanone, 2-hydroxy-1-4-(hydroxyethoxy)phenyl-2-methyl-1-propanone.

In some embodiments, the adhesive compositions described herein further comprise a tackifier. The term “tackifier” as used herein means any composition which is useful to impart tack to the hot melt adhesive composition. ASTM D-1878-1T defines tack as “the property of a material which enables it to form a bond of measurable strength immediately on contact with another surface”.

In some embodiments, a suitable tackifer, as would be appreciated by the skilled artisan, is a tackifier that is able to mix with adhesive polymer, e.g., (meth)acrylic co-polymer. In one preferred embodiment, the tackifier is a resin-based tackifier, and more specifically rosin esters and rosin acids and hydrogenated versions thereof. Suitable examples include, but are not limited to, Foral 85 (Eastman), Pine Crystal KE 311 (Arakawa) and Staybelite Ester 10 (Hercules), as well as polyvinyl ethers, such as the Lutonal M40 grade from BASF. Other useful tackifiers include aliphatic and aromatic hydrocarbon resins, such as, for example, an alpha methyl styrene resin having a softening point of less than about 110° C. Examples include Kristalex 3085 (Kristalex F85), an alpha-methyl styrene resin having a softening point of about 85° C., and which is commercially available from Eastman Chemical.

In some embodiments, the adhesive composition contains no more than about 40 wt % of tackifier. In some embodiments, the adhesive composition contains from about 30 wt % to about 20 wt % of tackifier. In some embodiments, the adhesive composition contains about 10 wt %, about 15 wt %, about 20 wt %, about 25 wt %, about 30 wt %, about 35 wt %, or about 40 wt % of tackifier.

### Uses

In some embodiments, the adhesive composition containing the UV-curable acrylic co-polymers described herein is heated at a suitable temperature to provide a molten state, wherein the adhesive composition may be spread and applied to the reverse face of the floor covering element. In some embodiments, the suitable temperature is from about 80° C. to about 180° C. In some embodiments, the suitable temperature is from about 80° C. to about 160° C. In some embodiments, the suitable temperature is from about 120° C. to about 160° C. Then, the adhesive composition on the reverse face of the floor covering element, is subjected to UV irradiation at a suitable wavelength to initiate photocuring. In some embodiments, the suitable wavelength is from about 220 nm to about 290 nm. In some embodiments, the suitable wavelength is from about 240 nm to about 270 nm. In some embodiments, the suitable wavelength is from about 250 nm to about 260 nm. After curing, the floor covering element is allowed to cool to room temperature and the adhesive is then covered with a release liner. The floor covering element can then be used to adhesively bond to a floor substrate by removing the release liner and directly applying the floor covering element to the desired floor substrate with the face containing the adhesive contacting the floor substrate.

Provided in another aspect is a method for preparing a floor covering element, the method containing:
heating a UV-curable hot melt adhesive composition to a molten state at a temperature from about 80° C. to about 160° C. to provide a molten UV-curable hot melt adhesive;
applying the molten UV-curable hot melt adhesive to a reverse face of the floor covering element to provide an adhesive-coated floor covering;
exposing the UV-curable hot melt adhesive on the reverse face of the floor covering to ultraviolet radiation having a wavelength of about 250 nm to about 260 nm to photoinitiate curing of the disposed UV-curable hot melt adhesive to the floor covering element to form a cured floor covering element having cured adhesive; and
applying a release liner to cured adhesive;
wherein:
   the UV-curable hot melt adhesive composition contains a UV-curable acrylic co-polymer derived from a (meth)acrylic co-polymer covalently bound to a compound of Formula (I), (II), or (III) as described herein through the olefinic moiety of the compound.

In some embodiments, the heating a UV-curable hot melt adhesive composition to a molten state is at a temperature from about 120° C. to about 160° C. to provide a molten UV-curable hot melt adhesive.

The present invention, thus generally described, will be understood more readily by reference to the following examples, which are provided by way of illustration and are not intended to be limiting of the present invention.

### EXAMPLES

### General Procedures

GPC spectra were acquired with a Waters 2695 instrument and were used to determine molecular weight of polymers using THF as the mobile phase at 40° C. and a RI detector. All samples were analyzed for Mₙ, M_{w}, and PDI using elution times calibrated against polystyrene molecular weight standards.

The K values are determined according to DIN 53,726 in 1% strength solution in tetrahydrofuran at 25° C. The melt viscosities are measured using a plate-and-cone rheometer, for example Rotovisko RV 20 with a PK 100 measuring apparatus (Haake, Karlsruhe) (D=shear rate in 1/s).

### Example 1—UV-Curable Hot Melt Adhesive Acrylate Co-Polymer

One hundred fifty grams of a monomer mixture of 497 grams of n-butyl acrylate (BASF), 288.5 grams of 2-ethylhexyl acrylate (BASF), 184 grams of methyl acrylate (BASF), 25 g of acrylic acid (BASF) and 5.5 grams of 4-acryloxylbutylencarbonatobenzophenone are added to a mixture of 160 g of ethyl acetate, 50 g of tetrahydrofuran and 2 grams of tert-butyl peroxypivalate (Arkema).

The mixture is polymerized at 85° C. for 15 minutes. The remainder of the monomer mixture is added to the reaction mixture over the course of 2 hours and a solution of 2 g of tert-butyl peroxypivalate in 40 g of ethyl acetate is added simultaneously over the course of 3 hours. After the end of the monomer addition, polymerization reaction is continued for an additional 5 hours at 85° C.

An acrylate co-polymer having a benzophenone photoinitiator covalently attached to the polymer chain is obtained having a measured a K value of about 50. After the solvent and volatile components have been removed by vacuum distillation, the instant acrylate co-polymer has a melt viscosity of 52 Pa·s at 130° C., Tg=−34° C., Mn=15,000 g/mole, and Mw=203,000 g/mole.

### Example 2—UV-Curable Hot Melt Adhesive Acrylate Co-Polymer

One hundred fifty grams of a monomer mixture of 900 grams of 2-ethylhexyl acrylate (BASF), 90 grams of methyl methacrylate (BASF), and 10 grams of 4-acryloxylbutylen-carbonatobenzophenone are added to a mixture of 160 g of ethyl acetate, 50 g of tetrahydrofuran and 2.5 grams of tert-butyl peroxypivalate (Arkema).

The mixture is polymerized at 85° C. for 15 minutes. The remainder of the monomer mixture is added to the reaction mixture over the course of 2 hours and a solution of 2.5 g of tert-butyl peroxypivalate in 40 g of ethyl acetate is added simultaneously over the course of 3 hours. After the end of the monomer addition, polymerization reaction is continued for an additional 5 hours at 85° C.

An acrylate co-polymer having a benzophenone photoinitiator covalently attached to the polymer chain is obtained having a measured a K value of about 45. After the solvent and volatile components have been removed by vacuum distillation, the instant acrylate co-polymer has a melt viscosity of 25 Pa·s at 110° C., Tg=−60° C., Mn=13,300 g/mole, and Mw=234,000 g/mole.

### Example 3—UV-Curable Hot Melt Adhesive Acrylate Co-Polymer

One hundred fifty grams of a monomer mixture of 947.3 grams of n-butyl acrylate (BASF), 50 grams of acrylic acid (BASF), and 2.7 grams of 4-acryloxylbutylencarbonatobenzophenone are added to a mixture of 160 g of ethyl acetate, 50 g of tetrahydrofuran and 2.4 grams of tert-butyl peroxypivalate (Arkema).

The mixture is polymerized at 85° C. for 15 minutes. The remainder of the monomer mixture is added to the reaction mixture over the course of 2 hours and a solution of 2.4 g of tert-butyl peroxypivalate in 40 g of ethyl acetate is added simultaneously over the course of 3 hours. After the end of the monomer addition, polymerization reaction is continued for an additional 5 hours at 85° C.

An acrylate co-polymer having a benzophenone photoinitiator covalently attached to the polymer chain is obtained having a measured a K value of about 50. After the solvent and volatile components have been removed by vacuum distillation, the instant acrylate co-polymer has a melt viscosity of 83 Pa·s at 130° C., Tg=−39° C., Mn=13,600 g/mole, and Mw=211,000 g/mole.

### Example 4—UV-Curable Hot Melt Adhesive Acrylate Co-Polymer

One hundred fifty grams of a monomer mixture of 948.2 grams of n-butyl acrylate (BASF), 50 grams of acrylic acid (BASF), and 1.8 grams of 4-acryloxylbutylencarbonatobenzophenone are added to a mixture of 160 g of ethyl acetate, 50 g of tetrahydrofuran and 1.75 grams of tert-butyl peroxypivalate (Arkema).

The mixture is polymerized at 85° C. for 15 minutes. The remainder of the monomer mixture is added to the reaction mixture over the course of 2 hours and a solution of 1.75 g of tert-butyl peroxypivalate in 40 g of ethyl acetate is added simultaneously over the course of 3 hours. After the end of the monomer addition, polymerization reaction is continued for an additional 5 hours at 85° C.

An acrylate co-polymer having a benzophenone photoinitiator covalently attached to the polymer chain is obtained having a measured a K value of about 51. After the solvent and volatile components have been removed by vacuum distillation, the instant acrylate co-polymer has a melt viscosity of 88 Pa·s at 130° C., Tg=−39° C., Mn=12,500 g/mole, and Mw=212,000 g/mole.

### Example 5—UV-Curable Hot Melt Adhesive Acrylate Co-Polymer Application & Testing

The UV-curable hot melt adhesive acrylate co-polymer described in Instant Example 4 was heated to about 120° C. and cast at 176.9 grams per square meter film onto a silicone release liner using a hot melt coater to create a free film of adhesive. The adhesive free films were then transferred, using a rubber roller, onto rigid vinyl tiles, flexible vinyl tiles, and carpet backed vinyl tiles. Adhesive films were photocured using medium pressure mercury arc lamps using an IST UV curing laboratory unit. The UVC dose was measured and recorded using an EIT Power Puck. The UVC wavelength used was between 250 and 260 nm and irradiation took place in air. A UVC dosage of 100 mJ/cm² and a UVC intensity 109 mW/cm² were used to photochemically cure the adhesive films to the substrate or floor covering element. After curing, each tile was allowed to cool for approximately two hours before covering the adhesive with a release liner and then placement in a CTH room overnight for conditioning prior to testing. CTH Conditions=50% Relative Humidity at 73° F.

The tiles were cut into 1″×5″ testing strips with the 5″ direction in the coating and curing direction. Fourteen-inch pieces of masking tape were attached to the test strip to allow the testing strip to reach the load cell of the peel testing equipment. Three testing strips of the flexible tile and the carpet backed tile were laminated to a placard of plywood with a 4.5 lb rubber roller at a speed of 12 in/min. The rigid tile test strips were laminated to 2 mil chemically treated polyethylene terephthalate (PET) film. Each testing panel was allowed to condition for 20 minutes prior to 180 degree peel testing on an Instron peel tester (similar to ASTM D3330). The plywood (or 2 mil PET) was loaded into the bottom jaw of the Instron holder. The masking tape attached to the testing strip was loaded into the upper jaw of the Instron. The testing strips were peeled at a speed of 12 in/min. The average peel force and the failure mode of each peel were recorded. One mil=25.4 microns.

A second set of testing strips of the flexible tile and the carpet backed tile were laminated to a placard of plywood with a 4.5 lb rubber roller at a speed of 12 in/min. The rigid tile test strips were laminated to 2 mil chemically treated PET film. This set of samples were allowed to condition for 10 days at 120° F. These samples were allowed to condition at CTH conditions for approximately 2 hours before 180 degree peel testing on the Instron equipment.

A third set of testing strips of the flexible tile and the carpet backed tile were aged on liner for 10 days at 120° F. These samples on liner were allowed to condition at CTH conditions for approximately 2 hours before lamination. The flexible tile and carpet tile were laminated to plywood, while the rigid tile was laminated to 2 mil chemically treated PET. Each testing panel was allowed to condition for 20 minutes prior to 180 degree peel testing on an Instron peel tester.

Adhesive Failure=Adhesive remains bound to the tile that it was laminated to and no residue is found on either the plywood or 2 mil PET substrate.

Cohesive Failure=Adhesive film splits and part of the adhesive remains on the tile and part of it transfer to either the plywood or 2 mil PET substrate.

Adhesive Transfer=All of the adhesive transfers off of the tile and completely resides on either the plywood or 2 mil PET film.

Legging=Adhesive locally sticks to both the tile and either the plywood or 2 mil PET.

The values given in Tables 1-3 were averages of the results of three different tests.

TABLE 1
Initial Adhesive Results - Flooring with no aging

| 180 Degree Peel | | | Rigid |
|---|---|---|---|
| (20 min @ CTH) | Carpet Tile | Flexible Floor Tile | Floor Tile |
| Substrate | Plywood | Plywood | 2 mil PET |
| Average (lbs per | 8.15 | 7.16 | 10.84 |
| linear inch) | | | |
| Failure Mode | Cohesive/Adhesive | Cohesive | Cohesive |
| | Transfer | | |

TABLE 2
Adhesive Results - Flooring with aging on liner

| 180 Degree Peel | | | |
|---|---|---|---|
| (20 min @ CTH) - | | | |
| Aged on Liner | Carpet Tile | Flexible Floor Tile | Rigid Floor Tile |
| Substrate | Plywood | Plywood | 2 mil PET |
| Average (lbs per | 6.26 | 4.83 | 7.83 |
| linear inch) | | | |
| Failure Mode | Adhesive | Leggy Cohesive | Cohesive/Adhesive |
| | | | mix |

TABLE 3
Adhesive Results - Flooring with aging on Substrate

| 180 Degree Peel | | | |
|---|---|---|---|
| (20 min @ CTH) - | | | Rigid |
| Aged on Substrate | Carpet Tile | Flexible Floor Tile | Floor Tile |
| Substrate | Plywood | Plywood | 2 mil PET |
| Average (lbs per | 10.68 | 5.76 | 10.02 |
| linear inch) | | | |
| Failure Mode | Leggy Cohesive | Leggy Cohesive | Leggy Cohesive |

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1.-29. (canceled)

30. An article of manufacture comprising:
a floor covering element having an obverse face and a reverse face;
an adhesive layer applied to the reverse face; and
a release liner in adherence to the adhesive layer;
wherein:
the adhesive layer comprises a UV-curable hot melt adhesive composition comprising a UV-curable acrylic co-polymer derived from a (meth)acrylic co-polymer covalently bound to a compound of Formula (I), (II), or (III) through the olefinic moiety of the compound: 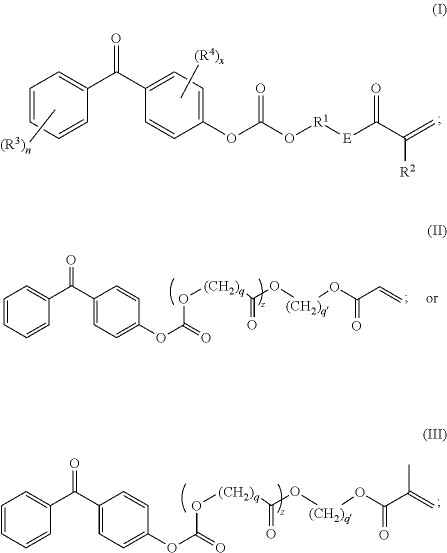
wherein:
R¹ is a linker group;
R² is H or alkyl;
E is O or NR⁵;
each R³ is individually a substituent selected from the group consisting of halogen, alkyl, O-alkyl, cycloalkyl, and an alkyl group containing a heteroatom, a halogen, a carbonyl group, alkoxy, or amino group;
each R⁴ is individually a substituent selected from the group consisting of halogen, alkyl, O-alkyl, cycloalkyl, and an alkyl group containing a heteroatom, a halogen, a carbonyl group, alkoxy, or amino group;
R⁵ is H or alkyl;
n is 0-5;
x is 0-4; and
each of q, q′, and z are individually 1-10.

31. The article of claim 30, wherein:
R¹ is arylene, cycloalkylenyl, —[C(R⁶)(R⁷)]_{n′}—, or —{[C(R⁶)(R⁷)]_{n′}C(O)}_{x′}[O(C(R⁶)(R⁷))_{y}]ₚ—;
each R⁶ is individually H, OR¹⁰, alkyl, aryl, or C(O)OH;
each R⁷ is individually H, OR¹⁰, alkyl, or aryl;
each R¹⁰ is individually H or alkyl;
n′ is 1-12;
y is 1, 2, or 3;
p is 1, 2, or 3; and
x′ is 1-10.

32. The article of claim 30, wherein R¹ is —(CH₂)_{n′}—, cyclohexan-1,4-yl, phenylen-1,4-yl, —[(CH₂)₃C(O)]₂—O—(CH₂)_{y}—, —C(CH₃)(C(O)OH)—, —C(H)(phenyl)C(CH₃)(H)—, or —CH₂C(CH₃)₂CH₂—.

33. The article of claim 30, wherein R¹ is —(CH₂)₃—; E is O; n is 0, x is 0, and R² is H or methyl.

34. The article of claim 30, wherein the compound of Formula (I), (II), or (III) is:

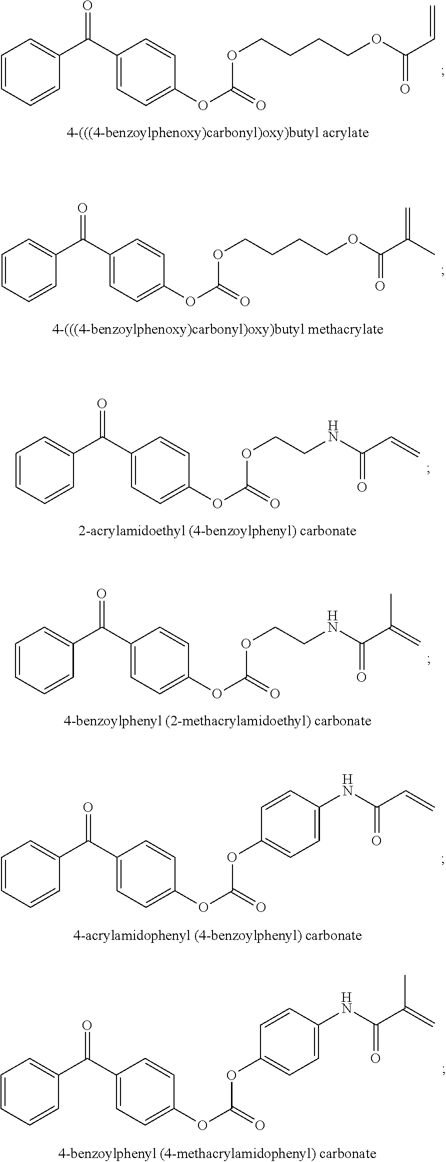 [SMILES: C=CC(=O)OCCCCOC(=O)Oc1ccc(C(=O)c2ccccc2)cc1 ; C=C(C)C(=O)OCCCCOC(=O)Oc1ccc(C(=O)c2ccccc2)cc1 ; C=CC(=O)NCCOC(=O)Oc1ccc(C(=O)c2ccccc2)cc1 ; C=C(C)C(=O)NCCOC(=O)Oc1ccc(C(=O)c2ccccc2)cc1 ; C=CC(=O)Nc1ccc(OC(=O)Oc2ccc(C(=O)c3ccccc3)cc2)cc1 ; C=C(C)C(=O)Nc1ccc(OC(=O)Oc2ccc(C(=O)c3ccccc3)cc2)cc1]

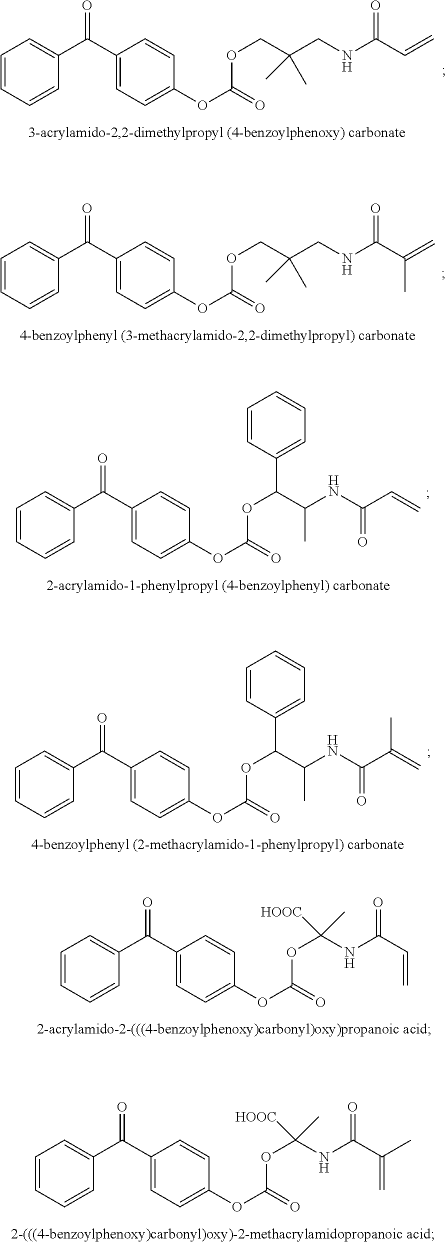 [SMILES: C=CC(=O)NCC(C)(C)COC(=O)Oc1ccc(C(=O)c2ccccc2)cc1 ; C=C(C)C(=O)NCC(C)(C)COC(=O)Oc1ccc(C(=O)c2ccccc2)cc1 ; C=CC(=O)NC(C)C(OC(=O)Oc1ccc(C(=O)c2ccccc2)cc1)c1ccccc1 ; C=C(C)C(=O)NC(C)C(OC(=O)Oc1ccc(C(=O)c2ccccc2)cc1)c1ccccc1 ; C=CC(=O)NC(C)(OC(=O)Oc1ccc(C(=O)c2ccccc2)cc1)C(=O)O ; C=C(C)C(=O)NC(C)(OC(=O)Oc1ccc(C(=O)c2ccccc2)cc1)C(=O)O]

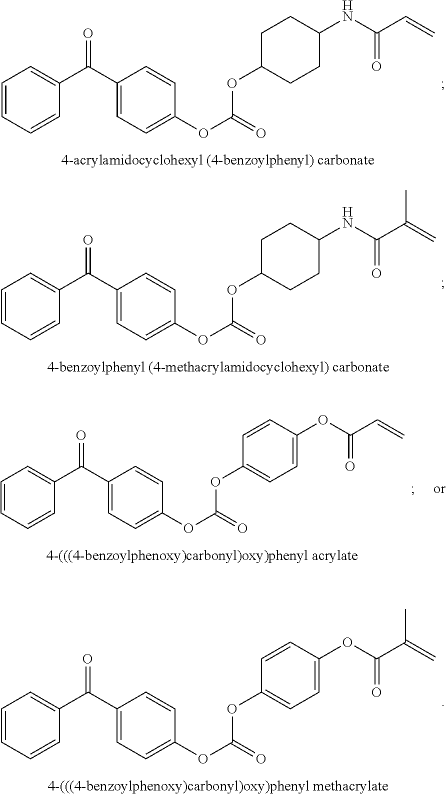 [SMILES: C=CC(=O)NC1CCC(OC(=O)Oc2ccc(C(=O)c3ccccc3)cc2)CC1 ; C=C(C)C(=O)NC1CCC(OC(=O)Oc2ccc(C(=O)c3ccccc3)cc2)CC1 ; C=CC(=O)Oc1ccc(OC(=O)Oc2ccc(C(=O)c3ccccc3)cc2)cc1 ; C=C(C)C(=O)Oc1ccc(OC(=O)Oc2ccc(C(=O)c3ccccc3)cc2)cc1]

35. The article of claim 30, wherein the compound of Formula (I), (II), or (III) is present from about 0.01 wt % to about 5 wt %, based on the solids of the UV-curable hot melt adhesive composition.

36. The article of claim 30, wherein the (meth)acrylic co-polymer is derived from a (meth)acrylic monomer containing acrylic acid, methacrylic acid, methylmethacrylic acid, methylmethacrylate, ethylmethacrylate, a hydroxy vinyl ether, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate, methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate, tetrahydropyranyl methacrylate, hydroxyalkyl acrylates and methacrylates, acrylic acid and its salts, acrylonitrile, acrylamide, methyl alpha-chloroacrylate, methyl 2-cyanoacrylate, N-ethylacrylamide, N,N-diethylacrylamide, acrolein, methacrylic acid and its salts, methacrylonitrile, methacrylamide, N-methylmethacrylamide, N-ethylmethacrylamide, N,N-diethylmethacrylamide, N,N-dimethylmethacrylamide, N-phenylmethacrylamide, methacrolein, or a mixture of any two or more thereof.

37. The article of claim 30, wherein the UV-curable acrylic polymer has a weight average molecular weight (M_{W}) is from about 30,000 g/mol to about 300,000 g/mol.

38. The article of claim 30, wherein the UV-curable acrylic polymer has a weight average molecular weight (M_{W}) is from about 40,000 g/mol to about 300,000 g/mol.

39. The article of claim 30, wherein the UV-curable acrylic polymer has a weight average molecular weight (M_{W}) is from about 50,000 g/mol to about 300,000 g/mol.

40. The article of claim 30, wherein the UV-curable acrylic polymer has a weight average molecular weight (M_{W}) is from about 100,000 g/mol to about 300,000 g/mol.

41. The article of claim 30, wherein the UV-curable hot melt adhesive composition further comprises an antioxidant.

42. The article of claim 30, wherein the UV-curable hot melt adhesive composition further comprises a tackifier.

43. The article of claim 30, wherein the UV-curable hot melt adhesive composition is essentially free of solvents and volatile components.

44. A method for preparing a floor covering element, the method comprising:
heating a UV-curable hot melt adhesive composition to a molten state at a temperature from about 80° C. to about 160° C. to provide a molten UV-curable hot melt adhesive;
applying the molten UV-curable hot melt adhesive to a reverse face of the floor covering element to provide an adhesive-coated floor covering;
exposing the UV-curable hot melt adhesive on the reverse face of the floor covering to ultraviolet radiation having a wavelength of about 250 nm to about 260 nm to photoinitiate curing of the disposed UV-curable hot melt adhesive to the floor covering element to form a cured floor covering element having cured adhesive; and
applying a release liner to cured adhesive;
wherein:
the UV-curable hot melt adhesive composition comprises a UV-curable acrylic co-polymer derived from a (meth)acrylic co-polymer covalently bound to a compound of Formula (I), (II), or (III) through the olefinic moiety of the compound: 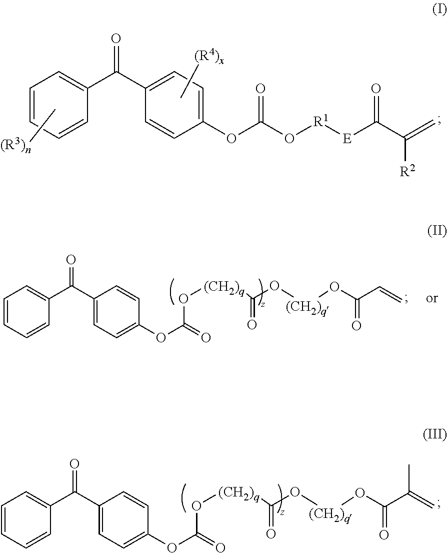
wherein:
R¹ is a linker group;
R² is H or alkyl;
E is O or NR⁵;
each R³ is individually a substituent selected from the group consisting of halogen, alkyl, O-alkyl, cycloalkyl, and an alkyl group containing a heteroatom, a halogen, a carbonyl group, alkoxy, or amino group;
each R⁴ is individually a substituent selected from the group consisting of halogen, alkyl, O-alkyl, cycloalkyl, and an alkyl group containing a heteroatom, a halogen, a carbonyl group, alkoxy, or amino group;
R⁵ is H or alkyl;
n is 0-5;
x is 0-4; and
each of q, q′, and z are individually 1-10.

45. The method of claim 44, wherein the heating a UV-curable hot melt adhesive composition to a molten state is at a temperature from about 120° C. to about 160° C. to provide a molten UV-curable hot melt adhesive.

46. The method of claim 44, wherein:
R¹ is arylene, cycloalkylenyl, —[C(R⁶)(R⁷)]_{n′}—, or —{[C(R⁶)(R⁷)]_{n′}C(O)}_{x′}[O(C(R⁶)(R⁷))_{y}]ₚ—;
each R⁶ is individually H, OR¹⁰, alkyl, aryl, or C(O)OH;
each R⁷ is individually H, OR¹⁰, alkyl, or aryl;
each R¹⁰ is individually H or alkyl;
n′ is 1-12;
y is 1, 2, or 3;
p is 1, 2, or 3; and
x′ is 1-10.

47. The method of claim 44, wherein R¹ is —(CH₂)_{n′}—, cyclohexan-1,4-yl, phenylen-1,4-yl, —[(CH₂)₃C(O)]₂—O—(CH₂)_{y}—, —C(CH₃)(C(O)OH)—, —C(H)(phenyl)C(CH₃)(H)—, or —CH₂C(CH₃)₂CH₂—.

48. The method of claim 44, wherein R¹ is —(CH₂)₃—; E is O; n is 0, x is 0, and R² is H or methyl.

49. The method of claim 44, wherein the compound of Formula (I), (II), or (III) is:

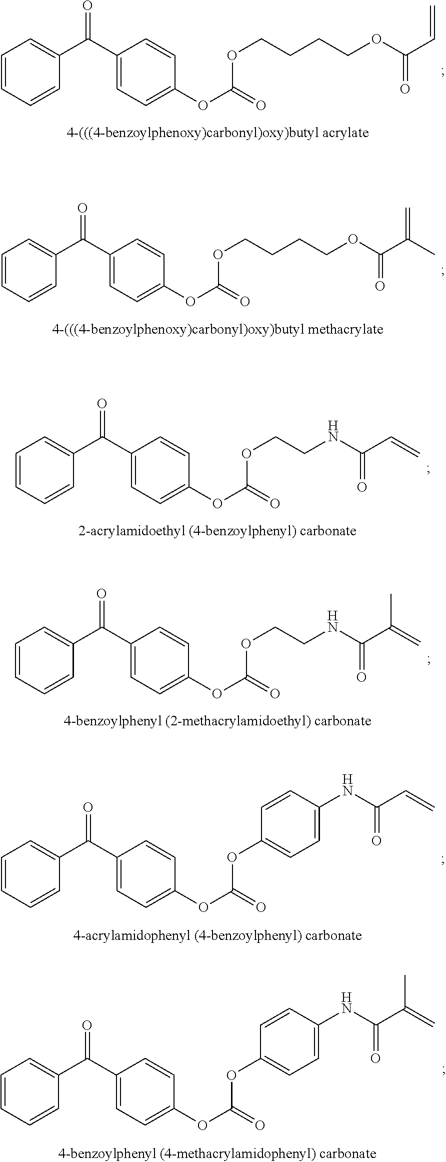 [SMILES: C=CC(=O)OCCCCOC(=O)Oc1ccc(C(=O)c2ccccc2)cc1 ; C=C(C)C(=O)OCCCCOC(=O)Oc1ccc(C(=O)c2ccccc2)cc1 ; C=CC(=O)NCCOC(=O)Oc1ccc(C(=O)c2ccccc2)cc1 ; C=C(C)C(=O)NCCOC(=O)Oc1ccc(C(=O)c2ccccc2)cc1 ; C=CC(=O)Nc1ccc(OC(=O)Oc2ccc(C(=O)c3ccccc3)cc2)cc1 ; C=C(C)C(=O)Nc1ccc(OC(=O)Oc2ccc(C(=O)c3ccccc3)cc2)cc1]

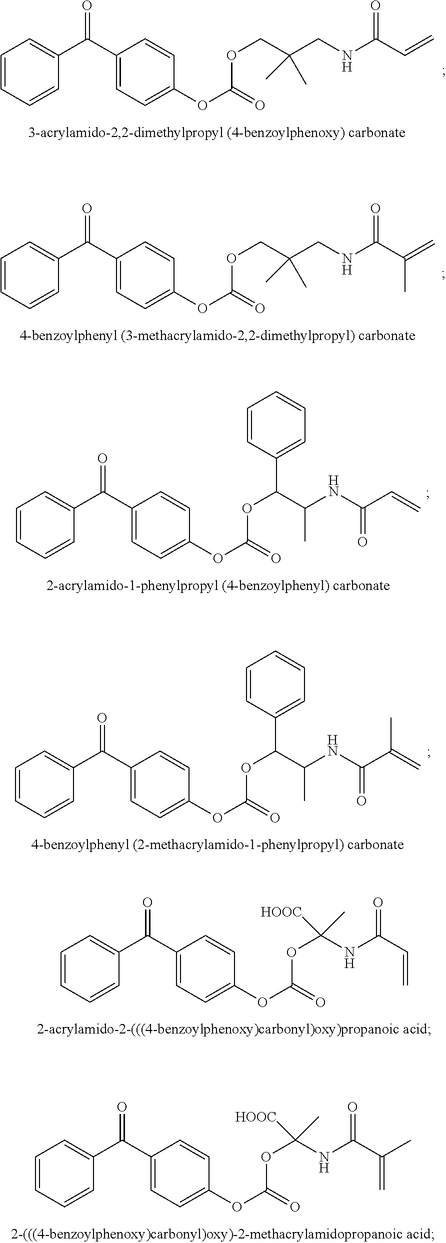 [SMILES: C=CC(=O)NCC(C)(C)COC(=O)Oc1ccc(C(=O)c2ccccc2)cc1 ; C=C(C)C(=O)NCC(C)(C)COC(=O)Oc1ccc(C(=O)c2ccccc2)cc1 ; C=CC(=O)NC(C)C(OC(=O)Oc1ccc(C(=O)c2ccccc2)cc1)c1ccccc1 ; C=C(C)C(=O)NC(C)C(OC(=O)Oc1ccc(C(=O)c2ccccc2)cc1)c1ccccc1 ; C=CC(=O)NC(C)(OC(=O)Oc1ccc(C(=O)c2ccccc2)cc1)C(=O)O ; C=C(C)C(=O)NC(C)(OC(=O)Oc1ccc(C(=O)c2ccccc2)cc1)C(=O)O]

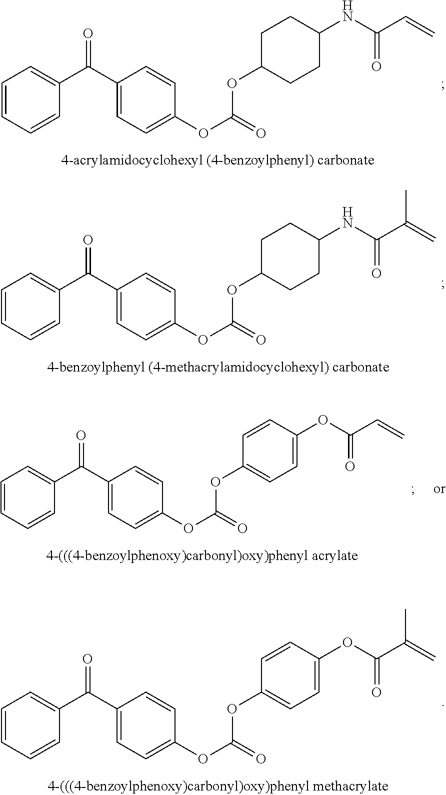 [SMILES: C=CC(=O)NC1CCC(OC(=O)Oc2ccc(C(=O)c3ccccc3)cc2)CC1 ; C=C(C)C(=O)NC1CCC(OC(=O)Oc2ccc(C(=O)c3ccccc3)cc2)CC1 ; C=CC(=O)Oc1ccc(OC(=O)Oc2ccc(C(=O)c3ccccc3)cc2)cc1 ; C=C(C)C(=O)Oc1ccc(OC(=O)Oc2ccc(C(=O)c3ccccc3)cc2)cc1]

50. The method of claim 44, wherein the compound of Formula (I), (II), or (III) is present from about 0.01 wt % to about 5 wt %, based on the solids of the UV-curable hot melt adhesive composition.

51. The method of claim 44, wherein the (meth)acrylic co-polymer is derived from a (meth)acrylic monomer containing acrylic acid, methacrylic acid, methylmethacrylic acid, methylmethacrylate, ethylmethacrylate, a hydroxy vinyl ether, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate, methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate, tetrahydropyranyl methacrylate, hydroxyalkyl acrylates and methacrylates, acrylic acid and its salts, acrylonitrile, acrylamide, methyl alpha-chloroacrylate, methyl 2-cyanoacrylate, N-ethylacrylamide, N,N-diethylacrylamide, acrolein, methacrylic acid and its salts, methacrylonitrile, methacrylamide, N-methylmethacrylamide, N-ethylmethacrylamide, N,N-diethylmethacrylamide, N,N-dimethylmethacrylamide, N-phenylmethacrylamide, methacrolein, or a mixture of any two or more thereof.

52. The method of claim 44, wherein the UV-curable acrylic polymer has a weight average molecular weight (MW) is from about 30,000 g/mol to about 300,000 g/mol.

53. The method of claim 44, wherein the UV-curable acrylic polymer has a weight average molecular weight (M_{W}) is from about 40,000 g/mol to about 300,000 g/mol.

54. The method of claim 44, wherein the UV-curable acrylic polymer has a weight average molecular weight (M_{W}) is from about 50,000 g/mol to about 300,000 g/mol.

55. The method of claim 44, wherein the UV-curable acrylic polymer has a weight average molecular weight (M_{W}) is from about 100,000 g/mol to about 300,000 g/mol.

56. The method of claim 44, wherein the UV-curable hot melt adhesive composition further comprises an antioxidant.

57. The method of claim 44, wherein the UV-curable hot melt adhesive composition further comprises a tackifier.

58. The method of claim 44, wherein the UV-curable hot melt adhesive composition is essentially free of solvents and volatile components.
